(19) United States
(12) Patent Application Publication
(10) Pub. No.: US 2023/0406734 A1
(43) Pub. Date: Dec. 21, 2023

(54) Electrodeionization Configuration for Enhanced Boron Removal

(71) Applicant: Evoqua Water Technologies LLC, Pittsburgh, PA (US)

(72) Inventors: Jacob Telepciak, Littleton, MA (US); Jonathan Wood, Needham, MA (US); Krishna Kamath, Billerica, MA (US); Joshua Griffis, Ashburnham, MA (US); Nicholas Armstrong, East Hampstead, NH (US)

(73) Assignee: Evoqua Water Technologies LLC, Pittsburgh, PA (US)

(21) Appl. No.: 18/037,077

(22) PCT Filed: Nov. 12, 2021
(86) PCT No.: PCT/US21/59103

§ 371 Date: May 15, 2023

Related U.S. Application Data
(60) Provisional application No. 63/113,396, filed on Nov. 13, 2020.

(51) Int. Cl. C02F 1/469

(52) U.S. Cl. CPC C02F 1/469; C02F 2101/108; C02F 2201/002; C02F 2201/46115

(57) ABSTRACT

Electrochemical water treatment devices are disclosed. The device includes an electrochemical separation module fluidly connectable to the source of water to be treated. The electrochemical separation module includes a first electrode, a second electrode, and a plurality of dilution compartments. Each of the dilution compartments includes a first region of ion exchange media having a first average particle size, a second region of ion exchange media having a second average particle size, and a third region of ion exchange media having a third average particle size. A volume of the second region of ion exchange media being greater than or equal to a total volume of the first and third regions of ion exchange media. Methods of facilitating treatment of water containing weakly ionized species, e.g., dissolved boron containing species and dissolved silica containing species, are disclosed. Electrochemical separation modules are also disclosed.

### FIELD OF TECHNOLOGY

Aspects and embodiments disclosed herein relate to devices and methods for removing contaminants, for example, weakly ionized species such as dissolved boron-containing and silica-containing compounds from water, using electrodeionization.

### SUMMARY

In accordance with an aspect, there is provided an electrochemical water treatment device fluidly connectable to a source of water to be treated having weakly ionized species, e.g., dissolved boron species, i.e., boron-containing species. The device may include an electrochemical separation module fluidly connectable to the source of water to be treated. The electrochemical separation module may include a first electrode, a second electrode, and a plurality of dilution compartments. Each of the dilution compartments may include a first region of ion exchange media having a first average particle size, a second region of ion exchange media having a second average particle size, and a third region of ion exchange media having a third average particle size. A volume of the second region of ion exchange media may be greater than or equal to a total volume of the first and third regions of ion exchange media.

In some embodiments, the electrochemical water treatment device may be constructed and arranged to provide for greater than or equal to a 3-log removal of boron with a pressure drop of between about 30 psi and 70 psi in a single pass through the electrochemical water treatment device.

In certain embodiments, the second average particle size is less than the first average particle size and the third average particle size.

In some embodiments, the ion exchange media in the first region and the second region may include the same ion exchange media. In some embodiments, the ion exchange media in the second region and the third region may include the same ion exchange media. In some embodiments, the ion exchange media in the first region and the third region may include the same ion exchange media.

In particular embodiments, the second average particle size is in a range of between 100 μm to 400 μm. In some embodiments, the first average particle size is in a range between 500 μm to 800 μm.

In some embodiments, the second region of ion exchange media occupies about 50% to about 90% of the volume of the dilution compartment. In some embodiments, the total volume of the first and third regions is about 10% to about 50% of a volume of the dilution compartment.

In some embodiments, one or more of the first, second, or third regions of ion exchange media may include a mixture of two or more ion exchange media. For example, in one or more of the first, second, or third regions of ion exchange media, the mixture may include a mixture of at least one cation exchange resin and at least one anion exchange resin. In particular embodiments, the at least one cation exchange resin may be a strong acid cation exchange resin and the at least one anion exchange resin may be a strong base anion exchange resin. In certain embodiments, the mixture of the at least one cation exchange resin and the at least one anion exchange resin comprises about 50% w/w of the at least one cation exchange resin and the mixture of the at least one cation exchange resin and the at least one anion exchange resin comprises about 50% w/w of the least one anion exchange resin.

In some embodiments, the at least one cation exchange resin has a cross-linked content of about 5% to 15% w/w. In some embodiments, the at least one cation exchange resin has a moisture content of between about 40% to 60%. In some embodiments, the at one least anion exchange resin has a cross-linked content of about 1% to 10% w/w. In some embodiments, the at least one anion exchange resin has a moisture content greater than about 40%. For example, the at least one anion exchange resin has a moisture content of between about 40% to 65%.

In some embodiments, a volume of the third region relative to a volume of the first and second regions provides a pressure drop through the module of no more than 60 psi.

In some embodiments, the electrochemical separation module may include between 100 to 150 electrochemical cells.

In further embodiments, the module may include a plurality of concentration compartments, each of which includes at least one ion exchange media. The plurality of concentration compartments may include a substantially identical arrangement of ion exchange media as the dilution compartments. In certain embodiments, the plurality of concentration compartments may include an ion exchange media having the first particle size.

In further embodiments, the device may include a first media retention structure disposed at one or both of an inlet and an outlet of the dilution compartments.

In accordance with an aspect, there is provided a method of facilitating reduction of boron in water. The method may include a step of providing an electrochemical water treatment device connectable to a source of water containing weakly ionized species, e.g., dissolved boron species, the electrochemical water treatment device including an electrochemical separation module. The provided electrochemical module may include a first electrode, a second electrode, and a plurality of fluidly coupled electrochemical cells therebetween, where each of the plurality of fluidly coupled electrochemical cells comprising at least a dilution compartment including a first layer of ion exchange media, a second layer of ion exchange media, and a third layer of ion exchange media. A volume of the second layer of ion exchange media may be greater than or equal to a total volume of the first and third layers of ion exchange media. The first, second, and third layers of ion exchange media may be arranged to provide for greater than or equal to a 3-log removal of the weakly ionized species, e.g., boron, from the water in a single pass through the electrochemical water treatment device. The method further may include providing instructions to direct water from the source of water to the feed inlet of the electrochemical separation module.

In further embodiments, the method may include providing instructions to apply a voltage across the first and second electrodes to produce a diluate stream with a reduced concentration of weakly ionized species, e.g., dissolved boron, and a concentrate stream enriched in weakly ionized species, e.g., dissolved boron.

In further embodiments, the method may include providing instructions to operate the electrochemical water treatment device with a pressure drop between about 30 psi to 70 psi.

In accordance with an aspect, there is provided an electrochemical separation module. The electrochemical separation module may include electrodes with a plurality of dilution compartments therebetween with each of the dilution compartments including an inlet region of ion exchange media distal to an inlet of each of the dilution compartments, an intermediate region of ion exchange media, and an outlet region of ion exchange media proximate an outlet of each of the dilution compartments. The intermediate region of ion exchange media may be disposed between the ion exchange media of the inlet region and the ion exchange media outlet region of each of the dilution compartments. The ion exchange media of the inlet region may have a first average interstitial spacing defined between adjacent ion exchange media particles and the ion exchange media of the outlet region may have a second average interstitial spacing defined between adjacent ion exchange media particles. The ion exchange media of the intermediate region may have an average particle size greater than the first and second average interstitial spacing. A volume of the intermediate region of ion exchange media may be greater than or equal to a total volume of the inlet and outlet regions of ion exchange media. The electrochemical separation module may be constructed and arranged to operate with a pressure drop between about 30 psi to 70 psi.

In some embodiments, the first average interstitial spacing may be within about 5% of the second average interstitial spacing. In some embodiments, the electrochemical separation module may be constructed and arranged to provide for greater than or equal to a 3-log removal of weakly ionized species, e.g., boron. In further embodiments, the electrochemical separation module may include a plurality of concentration compartments. In particular embodiments, the dilution compartments comprise at least one dimension greater than that of the concentration compartments, e.g., the dilution compartments may be thicker than the concentration compartments.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing. In the drawings:

FIG. 1 illustrates an electrochemical separation module, according to one embodiment;

FIG. 2 illustrates a water treatment system incorporating the electrochemical separation module of FIG. 1, according to one embodiment;

FIG. 3 illustrates a schematic of an electrochemical separation module of this disclosure, according to one embodiment; and

FIG. 4 illustrates the ion exchange media layout of an electrochemical separation module of this disclosure, according to one embodiment.

### DETAILED DESCRIPTION

Ion exchange is the reversible interchange of ions between a solid (for example, an ion exchange resin) and a liquid (for example, water). Since ion exchange media act as “chemical sponges,” they are well suited for effective removal of contaminants from water and other liquids. Ion exchange technology is often used in water demineralization and softening, wastewater recycling, and other water treatment processes. Ion exchange media are also used in a variety of specialized applications, for example, chemical processing, pharmaceuticals, mining, and food and beverage processing.

Devices for purifying fluids using electrical fields, i.e., electrochemical separation modules, may be used to treat water and other liquids containing dissolved ionic species. Within these modules are concentration and dilution (or depletion) compartments separated by ion-selective membranes. Electrochemical separation modules may feature alternating electroactive semipermeable anion and cation exchange membranes. Spaces between the membranes are configured to create liquid flow compartments with inlets and outlets. An applied electric field imposed via electrodes causes dissolved ions, attracted to their respective counter-electrodes, to migrate through the anion and cation exchange membranes. This generally results in the liquid of the diluting compartment being depleted of ions, and the liquid in the concentrating compartment being enriched with the transferred ions.

As used herein, the phrases “separation module,” “treatment device,” “purification device,” or “apparatus” pertain to any device that can be used to remove or reduce the concentration level of any undesirable species from a fluid to be treated. Examples of suitable treatment apparatuses include, but are not limited to, ion-exchange resin devices, reverse osmosis (RO), electrodeionization, electrodialysis, ultrafiltration, microfiltration, and capacitive deionization devices.

In certain non-limiting embodiments, the methods and devices disclosed herein comprise an electrochemical separation module. As used herein, the phrase “electrochemical separation module” refers to any number of electrically-driven separation systems; non-limiting examples including, but not limited to, electrodeionization (“EDI”) devices, electrodialysis (“ED”) devices, capacitive deionization (“CapDI”) devices, and any combination thereof. The electrochemical water treatment devices may include any device that functions in accordance with the principles of the systems and methods described herein as long as they are not inconsistent or contrary these operations.

In certain embodiments, the electrochemical separation module may include electrodeionization (EDI) units. Non-limiting examples of such devices include electrodialysis (ED), electrodialysis reversal (EDR), electrochemical deionization, capacitive deionization, continuous electrodeionization (CEDI), and reversible continuous electrodeionization (RCEDI).

Electrodeionization (EDI) is a process that removes, or at least reduces, one or more ionized or ionizable species from water using one or more ion exchange media and an electric potential applied between electrodes to influence ion transport. The ion exchange media typically serves to alternately collect and discharge ionic, weakly ionized species, and/or ionizable species and, in some embodiments, to facilitate the transport of ions, which may be continuously, by ionic or electronic substitution mechanisms. EDI devices can comprise electrochemically active media of permanent or temporary charge, and may be operated batch-wise, intermittently, continuously, and/or in reversing polarity modes. EDI devices may be operated to promote one or more electrochemical reactions specifically designed to achieve or enhance performance. Further, such electrochemical devices may comprise ion exchange membranes, such as semi-permeable or selectively permeable ion exchange or bipolar membranes. Continuous electrodeionization (CEDI) devices are EDI devices that operate in a manner in which water purification can proceed continuously, while ion exchange material is continuously recharged. CEDI techniques can include processes such as continuous deionization, filled cell electrodialysis, or electrodiaresis. Under controlled voltage and salinity conditions, in CEDI systems, water molecules can be split to generate hydrogen or hydronium ions or species and hydroxide or hydroxyl ions or species that can regenerate ion exchange media in the device and thus facilitate the release of the trapped species therefrom. In this manner, a water stream to be treated can be continuously purified without requiring chemical recharging of ion exchange media.

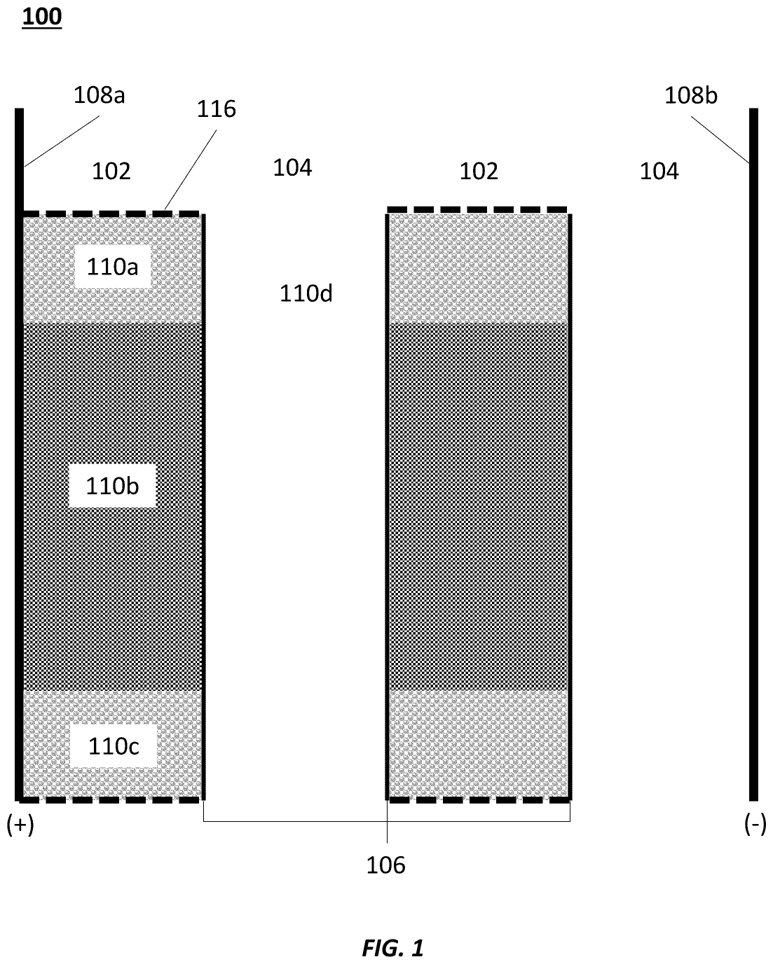

In CEDI and EDI devices, a direct current (DC) electric field is typically applied across the cells from a source of voltage and electric current applied to the electrodes (anode or positive electrode, and cathode or negative electrode). The voltage and current source (collectively “power supply”) can be itself powered by a variety of means such as an alternating current (AC) power source, or, for example, a power source derived from solar, wind, or wave power. At the electrode/liquid interfaces, electrochemical half-cell reactions occur that initiate and/or facilitate the transfer of ions through the membranes and compartments. For example, in FIG. 1, when a voltage is applied across the first and second electrodes, i.e., the cathode and anode, hydroxide and hydrogen ions may form in the water and may cause ions present in the water to migrate to the opposing polarity electrode.

In some embodiments, for electrodes contained within electrolyte compartments, the specific electrochemical reactions that occur at the electrode/interfaces can be controlled to some extent by the concentration of salts in the compartments. For example, a feed to the anode electrolyte compartment that is high in sodium chloride will tend to generate chlorine gas and hydrogen ions, while such a feed to the cathode electrolyte compartment will tend to generate hydrogen gas and hydroxide ions. Generally, the hydrogen ions generated in the anode compartment will associate with a free anion, such as chloride ion, to preserve charge neutrality and create hydrochloric acid solution, and analogously, the hydroxide ions generated at the cathode compartment will associate with a free cation, such as sodium, to preserve charge neutrality and create sodium hydroxide solution. The reaction products of the electrode compartments, such as generated chlorine gas and sodium hydroxide, can be utilized in the process as needed for disinfection purposes, for membrane cleaning and defouling purposes, and for pH adjustment purposes.

Water to be used for various industrial purposes, such as in the semiconductor industry, is generally highly pure water, such as ultrapure water (UPW) having a resistivity of 18.2 MΩ. In these high purity water sources, the presence of weakly ionized species, such as boron-containing species and silica-containing species, can be detrimental to numerous downstream processes, for example to the fabrication of microelectronics. To achieve this level of resistivity, the water should be free of as much of its ionic content as possible, including large and highly hydrated species and highly charged species or species which are only weakly ionized at approximately neutral pH, e.g., many boron-containing species. Boron-containing species are typically removed from process water, e.g., semiconductor fabrication process water, using multiple passes, i.e., serial passes, through a water treatment system including electrochemical removal and pressure-driven removal, such as reverse osmosis (RO). It is known that multi-module arrangements of either the same or different separation technologies, e.g., two or more EDI modules and/or more than one other electrochemical separation technique and/or pressure-driven separation, have been used to remove weakly ionized species, e.g., boron and boron-containing species, from water. For example, the removal of boron-containing species has been effectuated by the use of one or more EDI modules arranged in serial. This type of serially-arranged EDI system generally requires a large physical footprint, has complex piping and control schemes, and often has a water pressure drop through the multiple EDI modules that necessitates strong pumping action upstream of the EDI modules to produce sufficient pressure of treated water, increasing the costs to operate. It is an object of the present disclosure to provide a water treatment system having equal or better performance for removing weakly ionized species, e.g., boron-containing species and silica-containing species, with a smaller footprint and better economics than current removal technologies.

Electrochemical water treatment devices, e.g., CEDI and EDI devices, may include one or more, i.e., a plurality, of electrochemical separation modules having a plurality of adjacent electrochemical cells or compartments that are separated by selectively permeable membranes that allow the passage of either positively or negatively charged species, but typically not both. Dilution or depletion compartments are typically interspaced with concentrating or concentration compartments in such devices. In some embodiments, the plurality of electrochemical cells may be arranged serially, the dilution compartments of adjacent cells are coupled and the concentration compartments in adjacent cells are coupled.

The removal of weakly ionized species, e.g., boron-containing species and silica-containing species, from process water may be achieved by employing an electrochemical water treatment device having an electrochemical separation module that includes an increased number of dilution and concentration compartments relative to that of existing electrochemical treatment solutions. In a typical electrochemical treatment system, an electrochemical separation module may include approximately 100 electrochemical cell pairs, i.e., dilution-concentration compartment pairs, with two (or more) of these electrochemical separation modules fluidly connected in series to increase the treatment performance. For sufficient weakly ionized species, e.g., boron-containing species, removal, two passes through an electrochemical water treatment device of this design, for a total of water passage through 200 electrochemical cells, may be necessary.

As described herein, an electrochemical water treatment device may include an electrochemical separation module having an increased number of electrochemical cells, e.g., dilution-concentration compartment pairs, such as greater than 100 electrochemical cells. In some embodiments, an electrochemical separation module may include between about 100 to 150 electrochemical cells within the same physical footprint as an existing treatment solution. In particular embodiments, the electrochemical separation module may include 120 electrochemical cells.

In further embodiments, the electrochemical water treatment system may include a plurality of concentration compartments, each of which may include at least one ion exchange media. In some embodiments, the plurality of concentration compartments may not include an ion exchange media. In some embodiments, if ion exchange media is present, the concentration compartments may include a substantially identical arrangement of ion exchange media as the dilution compartments as described herein, i.e., having each of the dilution compartments including a first region of ion exchange media having a first average particle size, a second region of ion exchange media having a second average particle size, and a third region of ion exchange media having a third average particle size. In some embodiments, the concentration compartments may include an ion exchange media having the first particle size. For example, the concentration compartments may include an ion exchange media of a larger particle size that provides for at least partial removal of particular weakly ionized species, e.g., boron and silica. In particular embodiments, the dilution compartments include at least one ion exchange media having low or fine particle sizes and the concentration compartments include at least one ion exchange media having larger or coarse particle sizes as disclosed herein.

In general, the dilution compartments of the electrochemical separation module have at least one dimension, e.g., length, width, or thickness, greater than the same dimension of the concentration compartments. The relative difference in thickness between the dilution compartments and the concentration compartments represents a balance between product flow, flow rate, and control of the internal pressure of the electrochemical separation module. Dilution compartments that are thicker than the concentration compartments provide for a per-compartment increase in the flow rate capacity. In parallel, thinner concentration compartments provide for improved product recovery and for balancing the pressure within the electrochemical separation module. In some embodiments, the dilution compartments may have a thickness that is at least twice, i.e., 2×, that of the concentration compartments, e.g., at least 2×, at least 2.5×, at least 3×, at least 3.5×, at least 4×, at least 4.5×, or at least 5×. In particular embodiments, the dilution compartments are 3× thicker than the concentration compartments.

An embodiment of an electrochemical separation module, such as used in a CEDI or EDI device, is illustrated in FIG. 1. In FIG. 1, electrochemical separation module 100 includes dilution compartments 102, concentration compartments 104, and ion exchange membranes 106 separating dilution compartments 102 and concentration compartments 104. In some embodiments, there may be only one of each component, i.e., one dilution compartment 102, one concentration compartment 104, and one ion exchange membrane 106. As illustrated in FIG. 1, electrochemical separation module 100 may include a plurality of dilution compartments 102 and a plurality of concentration compartments 104 separated by an alternating series of ion exchange membranes 106, such as alternating cation exchange membranes and anion exchange membranes. In other embodiments, there may be a greater number of dilution and concentration compartments than illustrated in FIG. 1. The electrochemical separation module 100 is bounded by first and second electrodes 108a, 108b, operating as an anode and a cathode, respectively. Within the dilution compartments 102, a first region of the volume of the dilution compartment 102 includes a first ion exchange media 110a. A second region of the volume of the dilution compartments 102 includes a second ion exchange media 110b. A third region of the volume of the dilution compartments 102 includes a third ion exchange media 110c. As illustrated, a volume of the second region of ion exchange media being greater than or equal to a total volume of the first and third regions of ion exchange media. The concentration compartment 104 includes an ion exchange media 110d, but this is optional and not required for the electrochemical separation module 100 to operate.

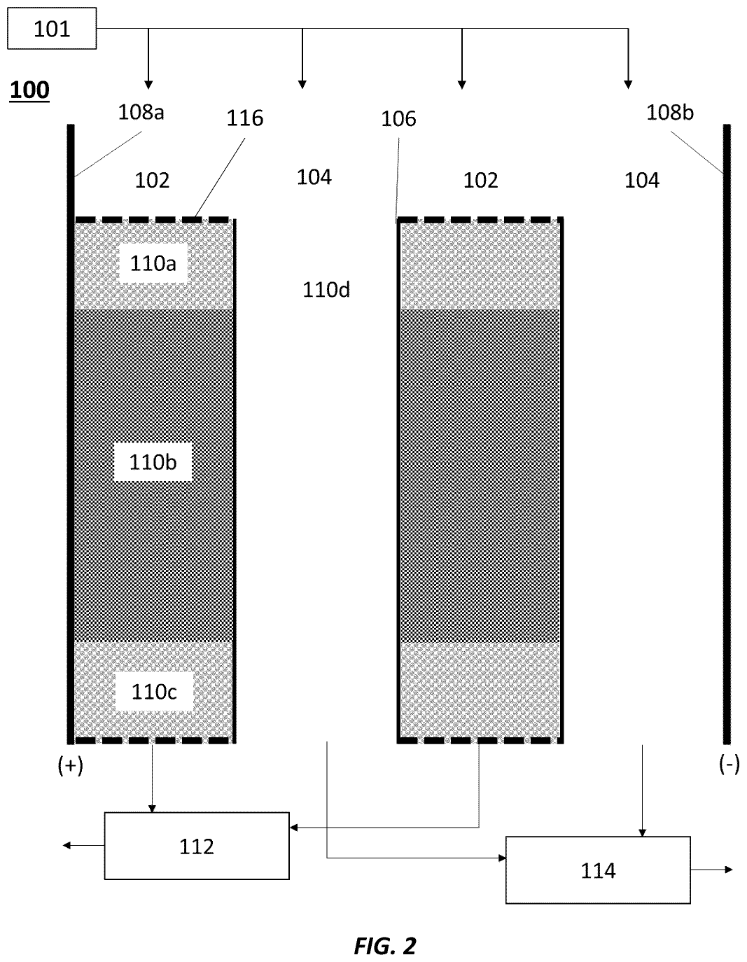

An embodiment of a water treatment device incorporating the electrochemical separation module illustrated in FIG. 1 is shown in FIG. 2. As shown, feed inlet 101, connected or connectable to a source of water including dissolved boron-containing species, and optionally silica containing species to be treated (not shown) is positioned to distribute water from the source of water into the dilution compartments 102 and concentration compartments 104 of the electrochemical separation module 100. As water flows through the depletion compartments 102 (shown as arrows in FIG. 2), ionic and other charged species are typically drawn into concentrating compartments 104 under the influence of an electric field, such as a DC field. Positively charged species are drawn toward a cathode, such as second electrode 108b located at one end of a stack of multiple depletion compartments 102 and concentration compartments 104, and negatively charged species are likewise drawn toward an anode such as first electrode 108a, located at the opposite end of the stack of compartments. The first and second electrodes 108a, 108b are typically housed in electrolyte compartments (not shown) that may be partially isolated from fluid communication with the depletion compartments 102 and/or concentration compartments 104. Once in a concentration compartment 104, charged species may be trapped by a barrier of an ion exchange membrane 106 that may at least partially define the concentration compartment 104. For example, anions may be prevented from migrating further toward the second electrode 108b and out of the concentration compartment 104 by a cation exchange membrane. Treated water in the dilution compartments 102 may be discharged out of product outlet 112 fluidly connected downstream of the electrochemical separation module 100. Once captured in the concentrating compartment 104, trapped charged species can be removed in a concentrate stream and discharged to waste outlet 114.

With continued reference to FIGS. 1 and 2, and in some embodiments, the electrochemical separation module 100 may include a media retention structure 116 disposed at one or both of an inlet or an outlet of the dilution compartments. The media retention structure may be used to reduce losses of ion exchange media during operation of the electrochemical separation module, such as during treatment or in a maintenance process, e.g., backwash or reverse flow. The media retention structure may be any suitable structure sized smaller than the ion exchange media positioned closest to the inlet or outlet of the electrochemical separation module, such as a mesh, a screen, or other similar structure. In some embodiments, both the inlet and outlet of the electrochemical separation module include media retention structures. The media retention structure further may include one or more structural features to aid in controlling or otherwise directing the flow of water either into or out of the dilution compartments.

The removal of weakly ionized species, e.g., boron-containing species and silica-containing species, from process water may be achieved by employing, within the dilution compartments of each electrochemical separation module a multi-region arrangement of ion exchange media with different physical and chemical properties. In some embodiments, each of the dilution compartments includes a first region of ion exchange media having a first average particle size, a second region of ion exchange media having a second average particle size, and a third region of ion exchange media having a third average particle size. The first, second, and third regions of ion exchange media may include any practical arrangement of ion exchange media to achieve removal of particular species, e.g., boron and silica, from water to be treated. For example, the ion exchange media in the first region and the second region comprise the same ion exchange media, i.e., have the same particle size and/or chemical composition. In some embodiments, the ion exchange media in the second region and the third region comprise the same ion exchange media, i.e., have the same particle size and/or chemical composition. In certain embodiments, the ion exchange media in the first region and the third region may include the same ion exchange media, i.e., have the same particle size and/or chemical composition. One of skill in the art would be able to determine an appropriate arrangement of ion exchange media in the first, second and third regions to effectuate a desired removal of particular weakly ionized species, e.g., boron and silica, from water to be treated.

In some embodiments, the arrangement of ion exchange media within the dilution compartments of the electrochemical separation module may be characterized by the spacing between the ion exchange media particles within different regions in the dilution compartments. In general, ion exchange media is constructed form spherical particulate media, and when disposed in the dilution and/or concentration compartments, the particles will have interstitial spaces between each particle, with the size of the interstitial spaces between particles being a function of the particle diameter. For example, an electrochemical separation module may include a type of ion exchange media in an inlet region of a dilution compartment positioned distal to an inlet of the electrochemical separation module, a type of ion exchange media in an outlet region of a dilution compartment positioned proximate to an outlet of the electrochemical separation module, and an intermediate region of a type of ion exchange media positioned between the inlet and outlet regions of ion exchange media. The ion exchange media of the inlet region may have a first average interstitial spacing and the ion exchange media of the outlet region may have a second average interstitial spacing. As used herein, “average interstitial spacing” refers to the average spacing between adjacent individual ion exchange media particles. In some embodiments, the ion exchange media of the intermediate region may have an average particle size greater than the first and second average interstitial spacing. In some embodiments, the first average interstitial spacing may be within about 5% of the second average interstitial spacing.

In some embodiments, the average particle size of the first region of ion exchange media and the third region of ion exchange media is greater than the average particle size of the second region of ion exchange media. For example, the first average particle size is in a range between 500 μm to 800 μm, e.g., between 500 μm to 800 μm, 550 μm to 750 μm, or 600 μm to 700 μm, e.g., about 500 μm, about 550 μm, about 600 μm, about 650 μm, about 700 μm, 7 about 50 μm, or about 800 μm. In some embodiments, the second average particle size is in a range of between 100 μm to 400 μm, e.g., between 100 μm to 400 μm, 125 μm to 375 μm, 150 μm to 350 μm, 175 μm to 325 μm, or 200 μm to 300 μm, e.g., about 100 μm, 125 μm, 150 μm, 175 μm, 200 μm, 225 μm, 250 μm, 275 μm, 300 μm, 325 μm, 350 μm, 375 μm, or 400 μm.

Without wishing to be bound by any particular theory, the removal performance for weakly ionized species, e.g., boron-containing species and silica-containing species, is a function of the average particle size of the ion exchange media and the total volume of ion exchange media present in the electrochemical separation module. Ion exchange media with a smaller average particle size generally exhibits increased removal performance for weakly ionized species, e.g., boron-containing species and silica-containing species, due to the increased surface area. The performance of finer mesh ion exchange media is balanced by smaller interstitial spaces between individual ion exchange media particles which generally increases the pressure drop of water exiting the electrochemical separation module. Ion exchange media with a larger average particle size, though not as effective for the removal of weakly ionized species, e.g., boron-containing species and silica-containing species, generally have a lower pressure drop and resist being carried away out of the electrochemical separation module upon pressurization of the electrochemical separation module. Thus, in some embodiments, a volume of the second region of ion exchange media may be greater than or equal to a total volume of the first and third regions of ion exchange media. For example, the second region of ion exchange media may have a total volume of about 50% or more of each dilution compartment of the electrochemical separation module, e.g., between 50% and 95% of the volume of each dilution compartment, e.g., between 50% and 95%, between 55% and 90%, between 60% and 85%, between 65% and 80%, or between 70-75%, e.g., about 50%, about 55%, about 60%, about 65%, about 70%, about 75%, about 80%, about 85%, about 90%, or about 95% of the volume of each dilution compartment. The total volume of the first and third regions of ion exchange media may be between 5% to about 50% of the volume of each the dilution compartment, e.g., between 5% and 50%, between 10% and 45%, between 15% and 40%, between 20% and 35%, or between 25-30%, e.g., about 5%, about 10%, about 15%, about 20%, about 25%, about 30%, about 35%, about 40%, about 45%, or about 20% of the volume of each dilution compartment. As a non-limiting example, the second region of ion exchange media may have a total volume of 70% of each dilution compartment of electrochemical separation module. In this configuration, the total volume of the volume of the first and third regions of ion exchange media may occupy the remaining 30% of the volume of each dilution compartment of the electrochemical separation module. In some embodiments, the total volume of first and third regions of ion exchange media may be split evenly. Alternatively, the total volume of first and third regions of ion exchange media may be split differentially, i.e., the volume of the first region of ion exchange media may have a greater volume than the third region of ion exchange media, or vice versa.

Embodiments of electrochemical water treatment devices disclosed herein may be constructed and arranged to provide for greater than or equal to a 3-log removal of weakly ionized species, e.g., boron, with a pressure drop of between about 30 psi and 70 psi in a single pass through the electrochemical water treatment device. In some embodiments, the pressure drop of water through the electrochemical water treatment device is between about 30 psi and 70 psi, 35 psi and 65 psi, 40 psi and 60 psi, or 45 psi and 50 psi, e.g., 30 psi, 35 psi, 40 psi, 45 psi, 50 psi, 55 psi, 60 psi, 65 psi, or 70 psi. As described herein, the pressure drop of water through the electrochemical water treatment device is a function of the average size of the ion exchange media particles in the dilution compartment and the total volume of ion exchange media present. In particular embodiments, the volume of the second region relative to the volume of the first and third regions provides a pressure drop through the module of no more than 60 psi.

The regional arrangement, i.e., the first, second, and third regions of ion exchange media within the dilution compartments of the electrochemical separation module with the second region of ion exchange media having a smaller average particle size and greater total volume relative to the first and third regions of ion exchange media, provides for improved operation of the electrochemical water treatment system over existing treatment technologies. The increased number of electrochemical cells increases the retention time of water through the electrochemical water treatment device and reduces the water flow through each electrochemical cell. This, in turn, reduces the overall pressure drop through the electrochemical water treatment device in a single pass without loss of removal performance for weakly ionized species, boron-containing species and silica-containing species. In a similar way, the reduced water flow through each dilution-concentration compartment pair reduces the electrical load across the electrodes of the electrochemical separation module, decreasing the costs of operation without loss of removal performance for weakly ionized species, e.g., boron-containing species and silica-containing species.

In some embodiments water treatment systems disclosed herein, one, two, or all of the first region of ion exchange media, the second region of ion exchange media, and the third region of ion exchange media may include a mixture of two or more ion exchange media. For example, one, two, or all of the first region of ion exchange media, the second region of ion exchange media, and the third region of ion exchange media may be a mixture of at least one least one cation exchange resin and at least one anion exchange resin. The specific type(s) and specific amounts (% w/w or % v/v, for example) of each type of ion exchange media may be determined by the properties of the water to be treated, such as chemical composition. In some embodiments, a binary mixture of at least one cation exchange resin and an at least one anion exchange resin may be in equal amount, e.g., 50% of each polarity media in the mixture. Alternatively, the relative amounts of each polarity of ion exchange media may be determined, in part, by the balance between resin longevity, cost, and ion transport performance. In some embodiments, the at least one cation exchange resin is a strong acid cation exchange resin and the at least one anion exchange resin is a strong base anion exchange resin. These ion exchange resin types are only illustrative examples, and aspects and embodiments disclosed herein are not limited by the specific type and/or manufacturer of the ion exchange media. One of skill in the art would readily be able to select an appropriate resin for a specific application and desired water quality.

As described herein, an ion exchange media, i.e., a cation exchange resin or an anion exchange resin, may have a cross-linked content of about 1% to about 20% w/w, e.g., about 1% to about 20%, about 2% to about 18%, about 4% to about 16%, about 6% to about 14%, about 8% to about 12%, or about 10%, e.g., about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20%. The cross-linking may be achieved by the addition of a suitable cross-linking compound, such as divinylbenzene (DVB) in the appropriate amount. In particular embodiments, the at least one cation exchange resin has a cross-linked content of about 5% to 15% w/w. The cross-link percentage of the at least one cation exchange resin may be the same as the at least one anion exchange resin. In some embodiments, the cross-link percentage of the at least one cation exchange resin and the at least one anion exchange resin may be the same between the first and third regions of ion exchange media and the second region of ion exchange media. For example, the cross-link percentage of the at least one cation exchange resin in the first and third regions of the dilution compartments may be about 10% and, the cross-link percentage of the at least one anion exchange resin in the first and third regions of the dilution compartments may be about 4%. One of skill in the art will appreciate that these parameters can be adjusted to tailor performance or other operations parameters of the electrochemical water treatment device.

In other embodiments, the cross-link percentage of the at least one cation exchange resin and the at least one anion exchange resin may be the same the first and third regions of ion exchange media and the second region of ion exchange media. Alternatively, the cross-link percentage of the at least one cation exchange resin and the at least one anion exchange resin may be different between the first and third regions of ion exchange media and the second region of ion exchange media, i.e., a size dependence on the percentage of cross-linking.

In some embodiments, the at least one cation exchange resin and the at least one anion exchange resin may be characterized by its moisture content. The cross-linked percentage by weight may not be specified for ion exchange media but can be inferred from its water content with an approximate 1:1 correspondence. Without wishing to be bound by any particular theory, the moisture content of an ion exchange resin is a measure of the amount of hydration water that fills the voids in the solid resin matrix and is considered to be the maximum weight percent of water that the ion exchange media may absorb and retain when exposed to water. A resin with high moisture content includes less dry matter, i.e., the matrix is made from polystyrene with crosslinks of divinylbenzene that bridge the polystyrene chains. Increased water content (and thus less dry matter) may provide easier access for large ions to move in and out of the structure, but the increased water content reduces the physical strength and resistance to oxidative attack of the resin, both of which are generally provided by the crosslinked polymeric structure. In some embodiments, an ion exchange media may be considered as having a “high” cross-linked content if the moisture content of the ion exchange media is between about 40% to about 50% by weight. A “low” cross-linked ion exchange media may have a moisture content between about 50% to about 60% by weight. For example, one or both of the at least one cation exchange resin and the at least one anion exchange resin may have a moisture content of between about 40% to 65%, e.g., a moisture content of about 40% to 60%, about 45% to 55%, or about 50%, e.g., a moisture content of about 40%, 41%, 42%, 43%, 44%, 45%, 46%, 47%, 48%, 49%, 50%, 51%, 52%, 53%, 54%, 55%, 56%, 57%, 58%, 59% or 60%. In particular embodiments, the at least one cation exchange resin has a moisture content of 50% to 55%. In particular embodiments, the at least one anion exchange resin has a moisture content of at least 40%, e.g., at least 45% to 55%, and up to 65%.

In accordance with an aspect, there is provided a method of facilitating reduction of weakly ionized species, e.g., boron, in water. The method may include providing an electrochemical water treatment device connectable to a source of water containing weakly ionized species, e.g., dissolved boron species. The provided electrochemical separation module may include a first electrode, a second electrode, and a plurality of fluidly coupled electrochemical cells therebetween. Each of the plurality of fluidly coupled electrochemical cells comprising at least a dilution compartment including a first layer of ion exchange media, a second layer of ion exchange media, and a third layer of ion exchange media. A volume of the second layer of ion exchange media being greater than or equal to a total volume of the first and third layers of ion exchange media with the first, second, and third layers of ion exchange media arranged to provide for greater than or equal to a 3-log removal of the weakly ionized species, e.g., boron, from the water in a single pass through the electrochemical water treatment device. The method further may include providing instructions to direct water from the source of water to the feed inlet of the electrochemical separation module.

In further embodiments, the method may include providing instructions to apply a voltage across the first and second electrodes to produce a diluate stream with a reduced concentration of weakly ionized species, e.g., dissolved boron, and a concentrate stream enriched in weakly ionized species, e.g., dissolved boron. In further embodiments, the method may include providing instructions to operate the electrochemical water treatment device with a pressure drop between about 30 psi to 70 psi.

In accordance with an aspect, there is provided an electrochemical separation module. The electrochemical separation module may include electrodes with a plurality of dilution compartments therebetween. Each of the dilution compartments may include an inlet region of ion exchange media distal to an inlet of each of the dilution compartments, an intermediate region of ion exchange media, and an outlet region of ion exchange media proximate an outlet of each of the dilution compartments. The ion exchange media of the inlet region may have a first average interstitial spacing defined between adjacent ion exchange media particles and the ion exchange media of the outlet region may have a second average interstitial spacing defined between adjacent ion exchange media particles. The ion exchange media of the intermediate region may have an average particle size greater than the first and second average interstitial spacing. A volume of the intermediate region of ion exchange media may be greater than or equal to a total volume of the inlet and outlet regions of ion exchange media. The electrochemical separation module may be constructed and arranged to operate with a pressure drop between about 30 psi to 70 psi. In some embodiments, the first average interstitial spacing may be within about 5% of the second average interstitial spacing. In some embodiments, the electrochemical separation module is constructed and arranged to provide for greater than or equal to a 3-log removal of weakly ionized species, e.g., boron. In further embodiments, the electrochemical separation module may include a plurality of concentration compartments. The dilution compartments may have at least one dimension greater than that of the concentration compartments. For example, the dilution compartments may be thicker than the concentration compartments.

### EXAMPLES

The function and advantages of these and other embodiments can be better understood from the following examples. These examples are intended to be illustrative in nature and are not considered to be in any way limiting the scope of the invention.

The following Examples reference specific ion exchange media available from commercial suppliers. Example anion exchange media suitable for use in an electrochemical separation module of this disclosure include, but are not limited to, SBA XFM (moisture content in OH⁻ form, 50-55%; moisture content in Cl⁻ form, 43-47%) available from Purolite (Bala Cynwyd, Pa.) and DOWEX® 1X4 (moisture content in Cl⁻ form min. 50%) available from the Dow Chemical Company (Midland, Mich.) and Type II strong base anion exchange resins. Example cation exchange media suitable for use in an electrochemical separation module of this disclosure include, but are not limited to, C-373 (moisture content 40-45% in Na⁺ form, 10% cross-linked) available from Evoqua Water Technologies, LLC (Pittsburgh, Pa.) and SAC XFM (moisture content in H⁺ form, 50-55%; moisture content in Na⁺ form, 45-50%) available from Purolite (Bala Cynwyd, Pa.). These media types are only illustrative examples, and aspects and embodiments disclosed herein are not limited by the specific type and/or manufacturer of the ion exchange media.

### Example 1

This example illustrates an EDI-based weakly ionized species removal system using the electrochemical separation modules as described herein, e.g., to affect a 3-log removal of boron-containing species from water.

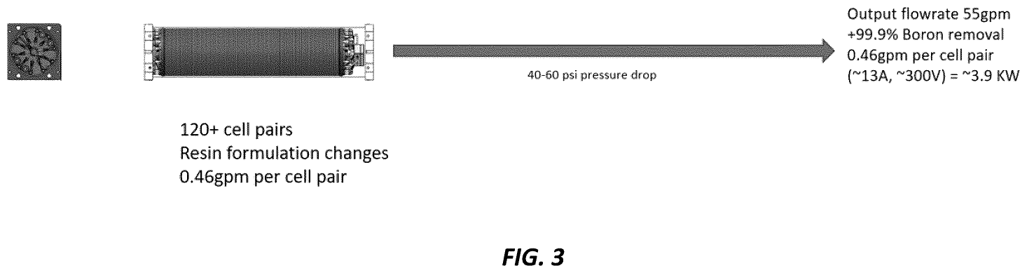

FIG. 3 illustrates a schematic of an electrochemical separation module of this disclosure, with Table 1 identifying the structural arrangement of the electrochemical separation module.

TABLE 1
Structural elements of an electrochemical separation
module of this disclosure.

| Parameter | Magnitude |
|---|---|
| Dimensions (L × W × H) | 84″ × 20″ × 20″ |
| # cell pairs | min. 120 |
| Plumbing interconnect for | No |
| cell pairs | |
| Output flow rate (gpm) | 55 |
| Boron removal (%) | 99.9% single pass |
| Flow per cell pair (gpm) | 0.46 |
| Total Pressure Drop (psi) | 40-60 |
| Power Consumption (kW) | 3.9 kW (300 V at 13A) |

As is seen in Table 1, the total pressure drop between the inlet and outlet is in the range of 40-60 psi and the footprint is about 14 ft². These values represented an improvement over known technologies for boron removal, such as larger EDI systems and pressure-driven separation, e.g., RO or nanofiltration (NF).

It was hypothesized that the removal performance of the electrochemical separation module could be improved by adjusting the quantities and types of ion exchange resin within the dilution compartments. One hypothesis that was tested was to adjust the ratio of fine mesh resin to standard size resin to get equal to or better boron and silica removal, noting that removal performance generally increased with the increased amount of fine mesh. Table 2 lists the types of resins used in an electrochemical separation module of this disclosure.

TABLE 2
Specific ion exchange resins used in the electrochemical separation
modules of this disclosure.

| | Resin | | Resin Amount |
|---|---|---|---|
| Mesh Type | Polarity | Resin Type | (wt. %) |
| Coarse | Cation | Evoqua C-373 (Na⁺ form) | 50 |
| | Anion | DOWEX ® XU-43593.00 (Cl⁻ | 50 |
| | | form) | |
| Fine | Cation | Purolite SAC XFM | 50 |
| | Anion | Purolite SBA XFM (Cl⁻ form) | 50 |

The ion exchange resins used comprised strong base anion and strong acid cation exchange resins. The resin mixture designated “Coarse” in Table 2 comprised cation exchange resin with a uniform particle size between 600 μm to 700 μm with 10% cross linking. The anion exchange resin comprised a uniform particle size of 575 μm+−50 μm with an approximate cross-linking of 4%. These resins were commercially available from Evoqua Water Technologies, LLC (Pittsburgh, Pa.) and Dow Chemical Company (Midland, Mich.). The resin mixture designated “Fine” in Table 3 comprised cation exchange resin with a particle size between 150 μm to 300 μm and a moisture content of 50 to 55% in the H⁺ form. The anion exchange resin comprised a particle between 150 μm to 300 μm and a moisture content of 50 to 55% in the OH⁻ form. These resins were available from the Purolite Company (Bala Cynwyd, Pa.). The resin mixtures all comprised a 50% ratio by weight of anion resin to cation resin.

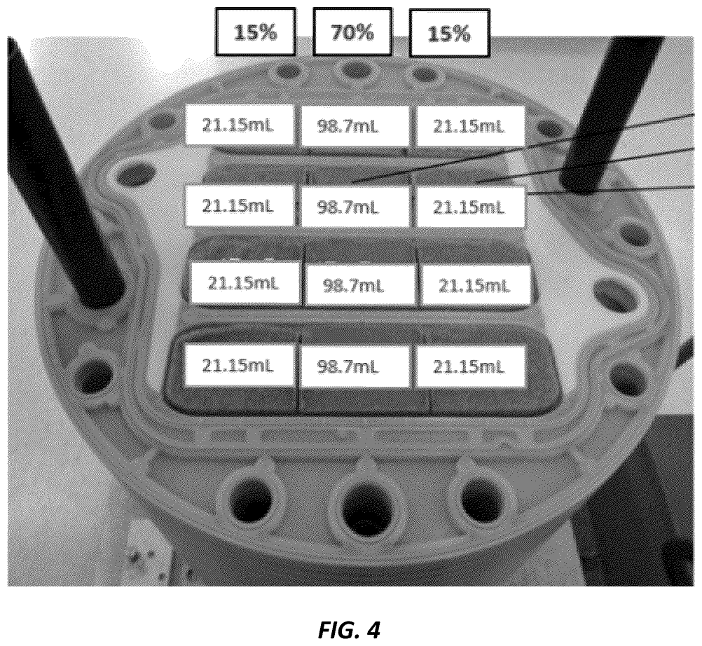

In the electrochemical separation module of this disclosure, the total weight percentage and ratio of coarse resin was decreased from a baseline value 33.33% on both sides of the fine mesh resin to 15% on both sides, bringing the total percentage of the coarse resin in the dilution compartment to 30%. The weight percentage and ratio of fine resin was increased from a baseline value of 33.33% in the center of the dilution compartment to 70%, and this resin configuration was evaluated for boron removal performance. This resin configuration is illustrated in FIG. 4. Table 3 lists the results of this evaluation at different levels of current applied to the electrodes of the electrochemical separation module at 300 V. As is seen, the single electrochemical separation module with the improved resin volumes had improved removal performance for both silica and boron at lower DC power consumption, which lowered operational costs.

TABLE 3
Boron and silica removal (log scale) for the modified resin
configuration as a function of applied current.

| Contaminant | 7 A | 10 A | 13.2 A |
|---|---|---|---|
| Silica | 2.78 | 2.73 | 3.00 |
| Boron | 3.13 | 3.34 | 3.51 |

These results represented an improvement over existing electrochemical separation techniques, which generally do not achieve 3-log removal of boron-containing species even at large applied currents, i.e., greater than 13.2 A.

Table 4 lists the feed water conditions for the evaluation of the resin configuration in the electrochemical separation module. Table 5 shows the removal performance for electrochemical separation modules with the modified resin configuration described herein. As noted, these results represented an improvement over existing electrochemical separation techniques, which generally do not achieve 3-log removal of boron-containing species without multiple passes through one or more additional separation techniques, such as a second EDI unit or other electrochemical or pressure-driven separation technique, e.g., RO.

TABLE 4
Feed water conditions for the evaluation of the resin configuration
in the electrochemical separation module.

| Parameter | Test 1 | Test 2 | Test 3 |
|---|---|---|---|
| Feed Conductivity (μS/cm) | 6.93 | 6.68 | 5.97 |
| Feed CO₂ (ppm) | 1.5 | 1.5 | 1.5 |
| Feed silica (ppb) | 20 | 20 | 17 |
| Feed boric acid (ppb) | — | — | 12 |
| Feed temperature (° C.) | 22.3 | 22.4 | 22.9 |

TABLE 5
Treatment results for the removal of silica and boron from
the feed water listed in Table 4.

| Parameter | Test 1 | Test 2 | Test 3 |
|---|---|---|---|
| Product Resistivity (MΩ-cm) | 18.46 | 18.45 | 18.47 |
| Silica Concentration (ppb) | — | — | 0 |
| Silica Removal (%) | — | — | 100 |
| Boron Concentration (ppb) | — | — | 0.01 |
| Boron Removal (%) | — | — | 99.917 |
| Dilute Pressure Drop (psi) | 23.3 | 23.4 | 23.2 |
| Conc. Pressure Drop (psi) | 3.3 | 3.5 | 3.4 |

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. An electrochemical water treatment device fluidly connectable to a source of water to be treated having weakly ionized species, comprising:
an electrochemical separation module fluidly connectable to the source of water to be treated, the electrochemical separation module comprising a first electrode, a second electrode, and a plurality of dilution compartments,
each of the dilution compartments including a first region of ion exchange media having a first average particle size, a second region of ion exchange media having a second average particle size, and a third region of ion exchange media having a third average particle size,
a volume of the second region of ion exchange media being greater than or equal to a total volume of the first and third regions of ion exchange media.

2. The device of claim 1, constructed and arranged to provide for greater than or equal to a 3-log removal of the weakly ionized species with a pressure drop of between about 30 psi and 70 psi in a single pass through the electrochemical water treatment device.

3. The device of claim 2, wherein the second average particle size is less than the first average particle size and the third average particle size.

4. The device of claim 2, wherein the ion exchange media in the first region and the second region comprise the same ion exchange media.

5. The device of claim 2, wherein the ion exchange media in the second region and the third region comprise the same ion exchange media.

6. The device of claim 2, wherein the ion exchange media in the first region and the third region comprise the same ion exchange media.

7. The device of claim 3, wherein the second average particle size is in a range of between 100 μm to 400 μm.

8. The device of claim 5, wherein the first average particle size is in a range between 500 μm to 800 μm.

9. The device of claim 3, wherein the second region of ion exchange media occupies about 50% to about 90% of the volume of the dilution compartment.

10. The device of claim 9, wherein the total volume of the first and third regions is about 10% to about 50% of a volume of the dilution compartment.

11. The device of claim 1, wherein one or more of the first, second, or third regions of ion exchange media comprises a mixture of two or more ion exchange media.

12. The device of claim 11, wherein the mixture of two or more ion exchange media comprises a mixture of at least one cation exchange resin and at least one anion exchange resin.

13. The device of claim 12, wherein the at least one cation exchange resin is a strong acid cation exchange resin.

14. The device of claim 12, wherein the at least one anion exchange resin is a strong base anion exchange resin.

15. The device of any one of claims 11-14, wherein the mixture of the at least one cation exchange resin and the at least one anion exchange resin comprises about 50% w/w of the at least one cation exchange resin.

16. The device of any one of claims 11-15, wherein the mixture of the at least one cation exchange resin and the at least one anion exchange resin comprises about 50% w/w of the least one anion exchange resin.

17. The device of claim 15, wherein the at least one cation exchange resin has a cross-linked content of about 5% to 15% w/w.

18. The device of claim 15, wherein the at least one cation exchange resin has a moisture content of between about 40% to 60%.

19. The device of claim 16, wherein the at one least anion exchange resin has a cross-linked content of about 1% to 10% w/w.

20. The device of claim 16, wherein the at least one anion exchange resin has a moisture content greater than about 40%.

21. The device of claim 16, wherein the at least one anion exchange resin has a moisture content of between about 40% to 65%.

22. The device of claim 1, wherein a volume of the third region relative to a volume of the first and second regions provides a pressure drop through the module of no more than 60 psi.

23. The device of claim 1, wherein the electrochemical separation module comprises between 100 to 150 electrochemical cells.

24. The device of claim 1, wherein the module further comprises concentration compartments, each of which includes at least one ion exchange media.

25. The device of claim 24, wherein the concentration compartments comprise a substantially identical arrangement of ion exchange media as the dilution compartments.

26. The device of claim 24, wherein the concentration compartments comprise an ion exchange media having the first particle size.

27. The device of claim 4 or 5, further comprising a first media retention structure disposed at one or both of an inlet and an outlet of the dilution compartments.

28. A method of facilitating reduction of weakly ionized species in water, the method comprising:
providing an electrochemical water treatment device connectable to a source of water containing weakly ionized species, the electrochemical water treatment device including an electrochemical separation module comprising:
a first electrode, a second electrode, and a plurality of fluidly coupled electrochemical cells therebetween, each of the plurality of fluidly coupled electrochemical cells comprising at least a dilution compartment including a first layer of ion exchange media, a second layer of ion exchange media, and a third layer of ion exchange media,
a volume of the second layer of ion exchange media being greater than or equal to a total volume of the first and third layers of ion exchange media with the first, second, and third layers of ion exchange media arranged to provide for greater than or equal to a 3-log removal of the weakly ionized species from the water in a single pass through the electrochemical water treatment device; and
providing instructions to direct water from the source of water to the feed inlet of the electrochemical separation module.

29. The method of claim 28, further comprising providing instructions to apply a voltage across the first and second electrodes to produce a diluate stream with a reduced concentration of weakly ionized species and a concentrate stream enriched in weakly ionized species.

30. The method of claim 29, further comprising providing instructions to operate the electrochemical water treatment device with a pressure drop between about 30 psi to 70 psi.

31. An electrochemical separation module comprising:
electrodes with a plurality of dilution compartments therebetween, each of the dilution compartments including an inlet region of ion exchange media distal to an inlet of each of the dilution compartments, an intermediate region of ion exchange media, and an outlet region of ion exchange media proximate an outlet of each of the dilution compartments,
the intermediate region of ion exchange media disposed between the ion exchange media of the inlet region and the ion exchange media outlet region of each of the dilution compartments,
the ion exchange media of the inlet region having a first average interstitial spacing defined between adjacent ion exchange media particles and the ion exchange media of the outlet region having a second average interstitial spacing defined between adjacent ion exchange media particles, the ion exchange media of the intermediate region having an average particle size greater than the first and second average interstitial spacing,
a volume of the intermediate region of ion exchange media being greater than or equal to a total volume of the inlet and outlet regions of ion exchange media,
the electrochemical separation module constructed and arranged to operate with a pressure drop between about 30 psi to 70 psi.

32. The module of claim 31, the first average interstitial spacing being within about 5% of the second average interstitial spacing.

33. The module of claim 31, wherein the electrochemical separation module is constructed and arranged to provide for greater than or equal to a 3-log removal of weakly ionized species.

34. The module of claim 31, further comprising a plurality of concentration compartments.

35. The module of claim 33, wherein the dilution compartments comprise at least one dimension greater than that of the concentration compartments.
